(19) United States
(12) Patent Application Publication
(10) Pub. No.: US 2025/0050782 A1
(43) Pub. Date: Feb. 13, 2025

(54) METHODS AND SYSTEM FOR DETECTING IDENTITY OF EVSE ELECTRIC COUPLERS

(71) Applicant: Ford Global Technologies, LLC, Dearborn, MI (US)

(72) Inventors: Colin T. Lieberman, Ferndale, MI (US); Christopher Ballard, Dearborn, MI (US); Prahlad Saggere, Wixom, MI (US)

(21) Appl. No.: 18/448,720

(22) Filed: Aug. 11, 2023

(51) Int. Cl. B60L 55/00; B60L 53/16; B60L 53/62; B60L 53/66

(52) U.S. Cl. CPC B60L 55/00; B60L 53/16; B60L 53/62; B60L 53/66; H02J 7/00045

(57) ABSTRACT

Methods and systems are provided for communicating operating conditions and operational limitations of an electric coupler that is external of a vehicle to the vehicle. In one example, functionality of a proximity detection circuit is enhanced to double as a serial communications link between a vehicle and an electric coupler.

### FIELD

The present description relates generally to methods and systems for identifying electric couplers for an electric vehicle. The methods and systems may be particularly useful when charging or discharging an electric vehicle.

### BACKGROUND/SUMMARY

An electric vehicle may receive and store electric charge for later use. While the most likely use for the stored charge may be to propel the electric vehicle, there may be other uses for the electric power that may occur from time to time. For example, the charge may be supplied to a second vehicle during situations where the second vehicle is low on charge. Additionally, the electric vehicle may provide electric power to external loads other than a vehicle. In particular, the electric power may be supplied to power tools, welders, refrigeration units, lifts, and other consumers of electric power. A power cable and an electric coupler (e.g., a device that includes a connector with pins and/or sockets that may transmit electrical power between a first location/device and a second location/device) may provide an electric coupling between the vehicle and an electrical load that is external to the vehicle (e.g., an external load). However, it may be expected that different manufacturers produce power cables and electric couplers with different electric current/power capacities according to the load that is being supplied with the electric power. If the current/power capacity of the power cable is less than the output capacity of the vehicle and less than the consumption capacity of the external load, the power cable may become degrade. Therefore, it may be desirable to provide a way of reducing a possibility of the power cable and/or electric coupling becoming degraded during charging of an external device.

It may be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 is a schematic diagram of an example vehicle driveline;

FIG. 2 is a schematic of an example circuit for communicating capacity of a power cable and electric coupler;

FIG. 3 shows an example sequence where power cable attributes are communicated to a charging device on board a vehicle so that electric power output from the vehicle may not exceed the capacity of a power cable and electric coupler;

FIG. 4 is a flowchart of an example method for determining and controlling power output from a vehicle to an external electric load; and

FIGS. 5 and 6 show an example electric coupler that includes a SAE J1772.

### DETAILED DESCRIPTION

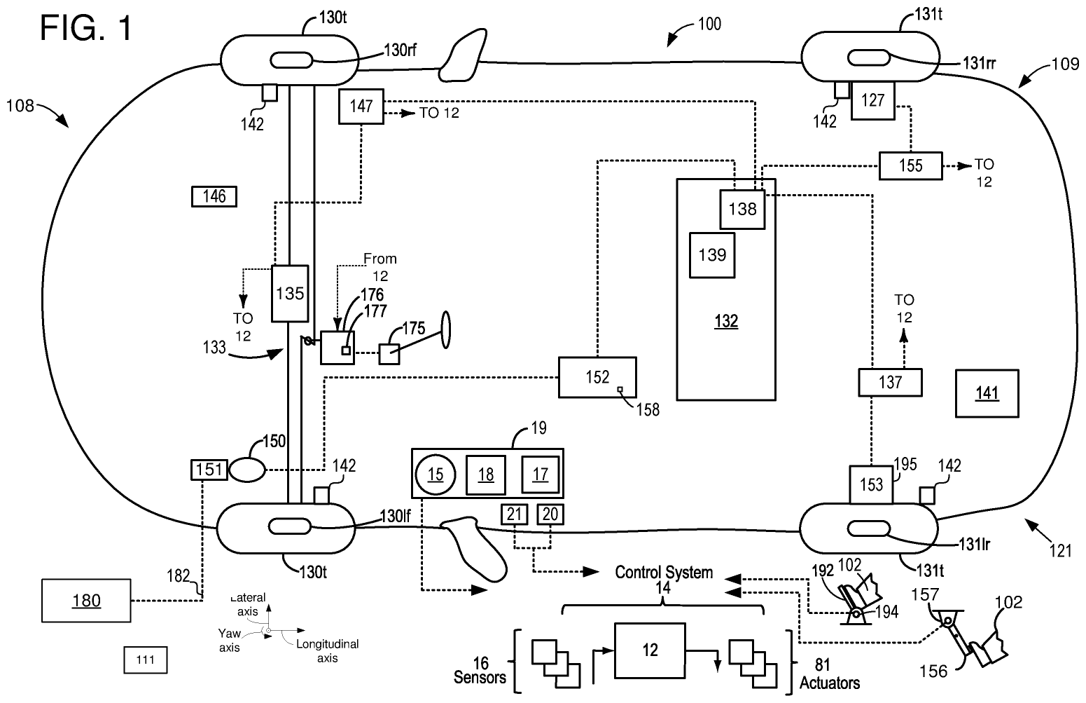

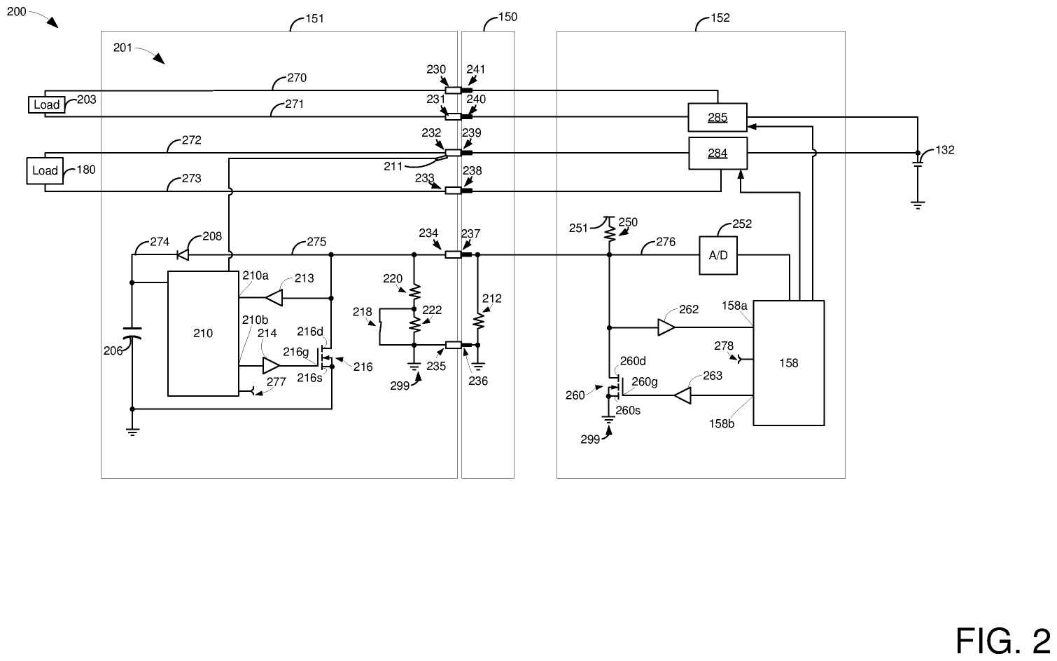

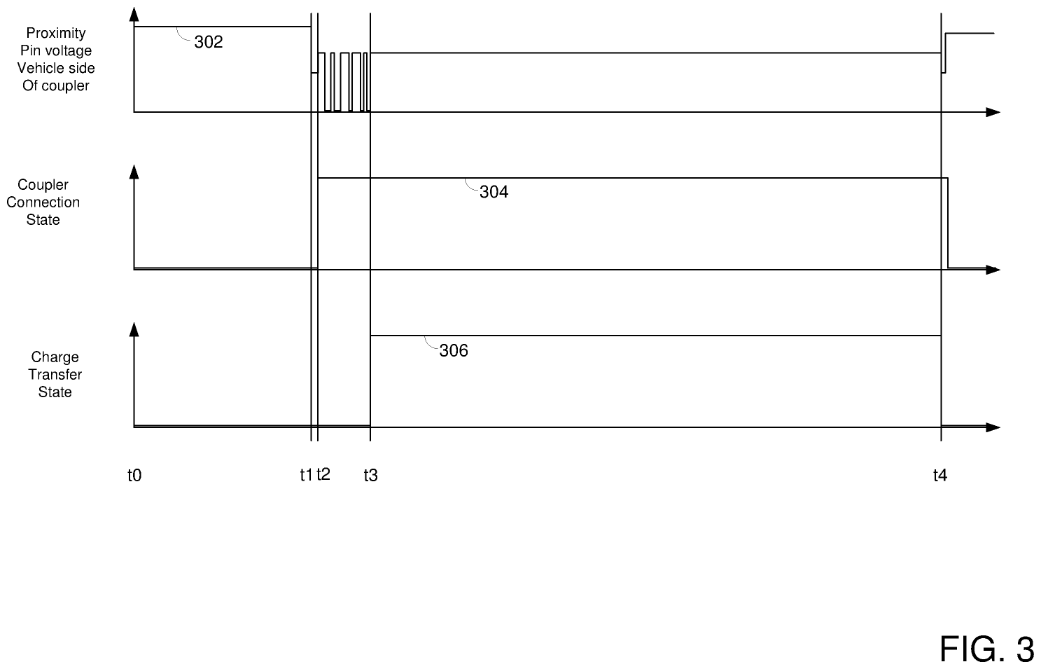

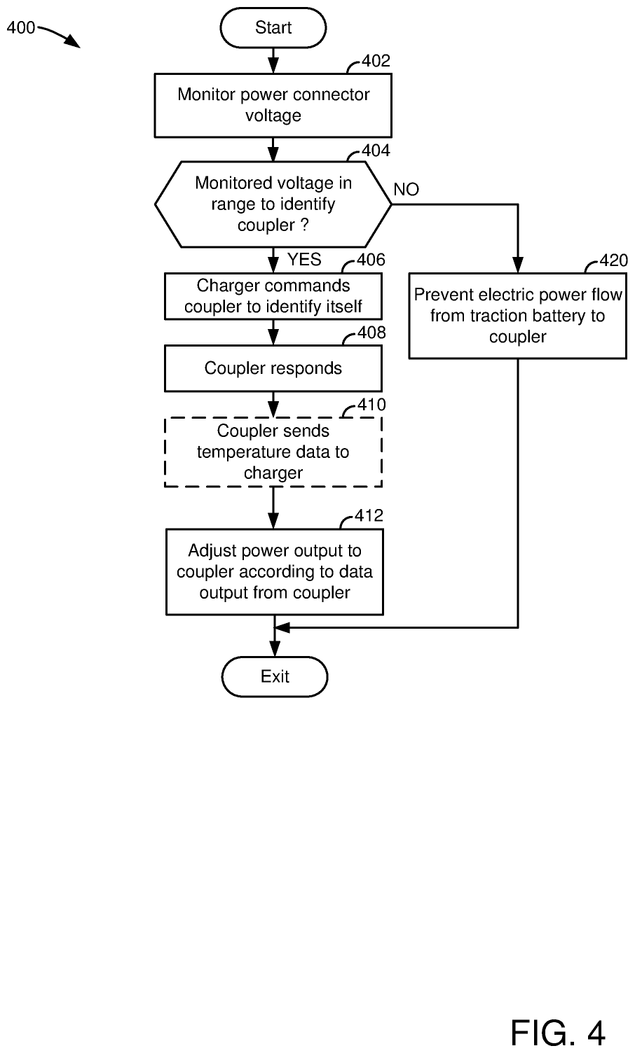

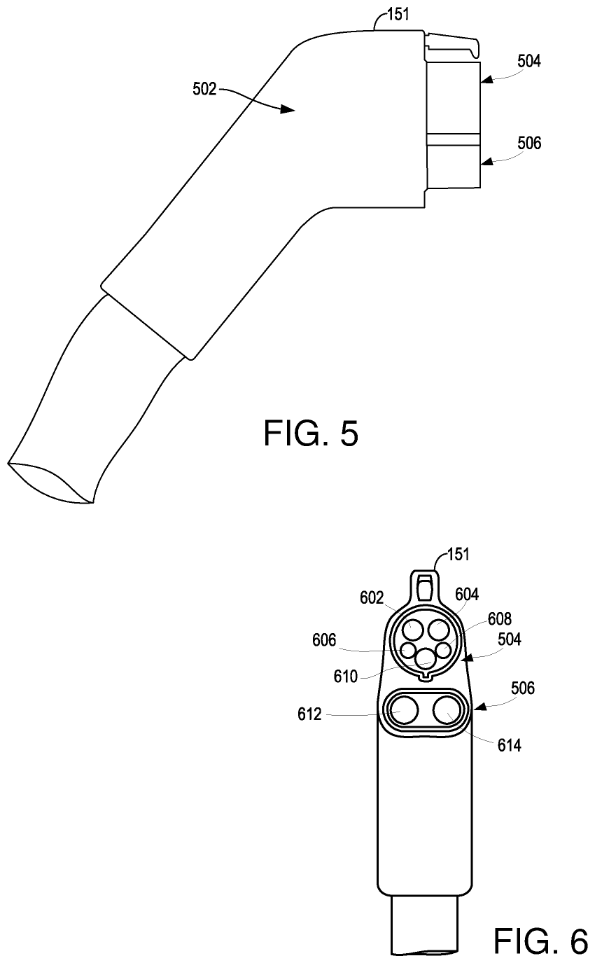

The following description relates to systems and methods for managing electric power delivery between a vehicle and an external device. FIG. 1 shows an example vehicle configuration that may exchange electrical power with an external device. Circuitry that communicates capabilities of an electric coupler to a vehicle is shown in FIG. 2. An example charge transfer sequence for an electric coupler is shown in FIG. 3. A method for exchanging electric coupler data and supplying charge to the electric coupler is shown in FIG. 4. FIGS. 5 and 6 show two different views of an example electric coupler.

An electric vehicle may export electric power to an electrical load that is external to the vehicle. The electrical load may consume less electric power than the electric vehicle has capacity to deliver or the electrical load may consume up to the electric vehicle's capacity to output electric power. Further, the electric vehicle may deliver electric power to different types of loads with different use requirements. For example, the electric vehicle may supply up to its capacity to an electrical power grid during times of high power consumption. On the other hand, the electric vehicle may supply electric power to a device that consumes a small amount of electric power while the vehicle is being used on a camping trip. Two different cables with different integrated electric couplers may be used to transfer electric power from the vehicle to the different loads. For example, a first cable and electric power electric coupler having capacity to transfer a larger amount of electric power (e.g., 19.2 kilowatts) may be used to transfer electric power between the electric vehicle and a stationary electric power grid. A second cable and electric power electric coupler having less capacity to transfer electric power (e.g., less than 10 kilowatts) may be used to transfer electric power during camping trips. In order to lower a possibility of the second cable degrading, it may be desirable to limit electric power output of the electric vehicle to a lower level when the second cable is plugged into the electric vehicle.

The inventors herein have recognized the above-mentioned issues and have developed a an electric coupler for an electric vehicle, comprising: an electric conductor electrically coupled a voltage divider circuit, a transistor, and circuitry configured to identify one or more attributes of the electric coupler.

By enhancing functionality of a proximity sensing circuit, it may be possible for an electric coupler to communicate its operating conditions and operating limitations to a vehicle so that the vehicle may adjust its electrical output responsive to the limitations and operating conditions of the electric coupler. For example, the voltage divider circuit may identify an electric coupler and cable as a device for supplying electrical charge to an external device. Additionally, voltage that is supplied to the voltage divider circuit may be modulated so as to provide serial communications capability between the electric coupler and the vehicle. The electric current and voltage capacity of the electric coupler may be sent to the electric vehicle from the electric coupler via serial communication.

The present description may provide several advantages. In particular, the approach may lower a possibility of charging cable degradation. Further, the approach may reduce a possibility of improperly rated charging cables and electric couplers from being used to transfer power from an electric vehicle. In addition, the approach may provide data that is more reliable for controlling electric vehicle output as compared to systems that include only a voltage divider circuit for cable and electric coupler identification.

FIG. 1 illustrates an example vehicle propulsion system 100 for vehicle 121. In this example, vehicle propulsion system 100 includes three electric machines that may be applied to propel vehicle 121. Throughout the description of FIG. 1, mechanical connections between various components are illustrated as solid lines, whereas electric connections between various components are illustrated as dashed lines.

In this example, vehicle propulsion system 100 includes an electric machine 153 coupled to solely one a wheel, namely left rear wheel 1311r. Vehicle propulsion system 200 also includes a second electric machine 127 that is coupled solely to one wheel, namely right real wheel 131rr. Vehicle propulsion system 100 drives front axle 133 and front wheels 1301f and 130rf via third electric machine 135. Front axle 133 is positioned toward front 108 of vehicle 121 and electric machines 153 and 127 are positioned toward rear 109 of vehicle 121. Thus, vehicle propulsion system 100 may be propelled by between one and three electric machines.

Electric machine 135, electric machine 127, and electric machine 153 are controlled via controller 12. The controller 12 (e.g., a centralized integrated vehicle control module) receives signals from the various sensors shown in FIG. 1. In addition, controller 12 employs the actuators shown in FIG. 1 to adjust driveline operation based on the received signals and instructions stored in memory of controller 12.

Vehicle propulsion system 100 has a front axle 133 and independently controlled rear wheels 131lr and 131rr. Vehicle propulsion system 100 further includes front wheels 1301f and 13rf. In this example, front wheels 1301f and 130rf and/or rear wheels 1311r and 131rr may be driven via electric propulsion sources. The front axle 133 is coupled to electric machine 135. Electric machine 135 is shown incorporated into front axle 133.

Electric machines 127, 153, and 135 may receive electrical power from onboard electric energy storage device 132. Furthermore, electric machines 127, 153, and 135 may provide a generator function to convert the vehicle's kinetic energy into electric energy, where the electric energy may be stored at electric energy storage device 132 for later use by the electric machine 127, 153, and/or 135. A first inverter system controller (ISC1) 137 may convert alternating current generated by electric machine 153 to direct current for storage at the electric energy storage device 132 and vice versa. First inverter system controller 137 may also convert direct current from electric energy storage device 132 into alternating current to power electric machine 153. A second inverter system controller (ISC2) 155 may convert alternating current generated by electric machine 127 to direct current for storage at the electric energy storage device 132 and vice versa. The second inverter system controller 155 may also convert alternating current generated by electric machine 127 to direct current for storage at the electric energy storage device 132 and vice versa. A third inverter system controller 147 may convert alternating current generated by electric machine 135 to direct current for storage at the electric energy storage device 132 and vice versa. Further, third inverter system controller 147 may convert direct current supplied by electric energy storage device 132 to power electric machine 135.

Electric energy storage device 132 may be a battery, capacitor, inductor, or other electric energy storage device. In some examples, electric energy storage device 132 may be configured to store electric energy that may be supplied to other electric loads residing on-board the vehicle (other than the motor), including cabin heating and air conditioning, headlights, cabin audio and video systems, etc.

Control system 14 may communicate with one or more of electric machine 135, electric machine 153, electric machine 127, energy storage device 132, etc. Control system 14 may receive sensory feedback information from one or more of electric machine 135, electric machine 127, electric machine 153, energy storage device 132, etc. Further, control system 14 may send control signals to one or more of electric machine 135, electric machine 127, electric machine 153, energy storage device 132, etc., responsive to this sensory feedback. Control system 14 may receive an indication of an operator requested output of the vehicle propulsion system from a human operator 102, or an autonomous controller. For example, control system 14 may receive sensory feedback from driver demand pedal position sensor 194 which communicates with driver demand pedal 192. Similarly, control system 14 may receive an indication of an operator requested vehicle braking via a human operator 102, or an autonomous controller. For example, control system 14 may receive sensory feedback from brake pedal position sensor 157 which communicates with brake pedal 156.

Energy storage device 132 may periodically receive and/or deliver electric energy via external device 180 (e.g., a stationary power grid, power tool, refrigeration unit, etc.) residing external to the vehicle (e.g., not part of the vehicle). As a non-limiting example, vehicle propulsion system 100 may be configured as a plug-in electric vehicle, whereby electric energy may be supplied to energy storage device 132 from external device 180 via an electric energy transmission cable 182 and electric coupler 151. During a charging or discharging operation of energy storage device 132 via external device 180, electric energy transmission cable 182 may electrically couple energy storage device 132 and external device 180. In some examples, external device 180 may be connected at electric port 150.

In some examples, electric energy from external device 180 may be received by charger 152. For example, charger 152 may convert alternating current from power source 180 to direct current (DC), for storage at energy storage device 132. Further, charger 152 may be bidirectional so as to convert DC from electric energy storage device 132 to AC for supply to external device 180. Further, charger 152 may step down or up DC voltage supplied from external device 180 to charge energy storage device 132. Additionally, charger 152 may step up or step down DC voltage from energy storage device 132 supplied to external device 180. Charger 152 may be controlled via its own dedicated controller 158 that includes non-transitory memory, a processor, inputs/outputs, and random access memory.

While the vehicle propulsion system is operated to propel the vehicle, electric energy transmission cable 182 may be disconnected between external device 180 and energy storage device 132. Control system 14 may identify and/or control the amount of electric energy stored at the energy storage device 132, which may be referred to as the state of charge (SOC).

Energy storage device 132 may include an electric energy storage device controller 139. Electric energy storage device controller 139 may provide charge balancing between energy storage element (e.g., battery cells) and communication with other vehicle controllers (e.g., controller 12).

One or more wheel speed sensors (WSS) 195 may be coupled to one or more wheels of vehicle propulsion system 100. The wheel speed sensors may detect rotational speed of each wheel. Such an example of a WSS may include a permanent magnet type of sensor.

Vehicle propulsion system 100 may further include an accelerometer 20. Additionally, vehicle propulsion system 100 may further include an inclinometer 21. Vehicle propulsion system 100 may also include a steering control system 176 that may adjust a steering angle via adjusting a position of steering motor 177.

Vehicle propulsion system 100 may further include a brake system control module (BSCM) 141 to apply and release friction wheel brakes 142. In some examples, BSCM 141 may comprise an anti-lock braking system, such that tires (e.g., 130t and 131t) of wheels (e.g. 1301f, 130rf, 1311r, and 131rr) may maintain tractive contact with the road surface according to driver inputs while braking, which may thus prevent the wheels from locking up, to prevent skidding. In some examples, BSCM 141 may receive input from wheel speed sensors 195.

Vehicle propulsion system 100 may further include a motor electronics coolant pump (MECP) 146. MECP 146 may be used to circulate coolant to diffuse heat generated by at least electric machine 127, electric machine 153, and electric machine 135 of vehicle propulsion system 100, and the electronics system. MECP may receive electrical power from onboard energy storage device 132, as an example.

Controller 12 may comprise a portion of a control system 14. In some examples, controller 12 may be a single controller of the vehicle. Control system 14 is shown receiving information from a plurality of sensors 16 (various examples of which are described herein) and sending control signals to a plurality of actuators 81 (various examples of which are described herein). As one example, sensors 16 may include tire pressure sensor(s) 197, wheel speed sensor(s) 195, etc. In some examples, steering angle sensor 175, sensors associated with electric machine 135, electric machine 127, and electric machine 153, etc., may communicate information to controller 12, regarding various states of electric machine operation.

Vehicle propulsion system 100 may also include an on-board navigation system 17 (for example, a Global Positioning System) on dashboard 19 that an operator of the vehicle may interact with. The navigation system 17 may include one or more location sensors for assisting in estimating a location (e.g., geographical coordinates) of the vehicle. For example, on-board navigation system 17 may receive signals from GPS satellites (not shown), and from the signal identify the geographical location of the vehicle. In some examples, the geographical location coordinates may be communicated to controller 12.

Dashboard 19 may further include a display system 18 configured to display information to the vehicle operator. Display system 18 may comprise, as a non-limiting example, a touchscreen, or human machine interface (HMI), display which enables the vehicle operator to view graphical information as well as input commands. In some examples, display system 18 may be connected wirelessly to the internet (not shown) via controller (e.g. 12). As such, in some examples, the vehicle operator may communicate via display system 18 with an internet site or software application (app).

Dashboard 19 may further include an operator interface 15 via which the vehicle operator may adjust the operating status of the vehicle. Specifically, the operator interface 15 may be configured to initiate and/or terminate operation of the vehicle driveline (e.g., electric machine 135, electric machine 127, and electric machine 153) based on an operator input. Various examples of the operator interface 15 may include interfaces that apply a physical apparatus, such as an active key, that may be inserted into the operator interface 15 to activate electric machines 135, 127, and 153, or may be removed to shut down the electric machines 135, 127, and 153 to turn off the vehicle. Still other examples, a start/stop button that is manually pressed by the operator may be applied to start or shut down the vehicle. In other examples, a remote vehicle start may be initiated remote computing device 111, for example a cellular telephone, or smartphone-based system where a user's cellular telephone sends data to a server and the server communicates with the vehicle controller 12 to start the vehicle.

Referring now to FIG. 2, a schematic 200 of an example circuit 201 for communicating capacity of an electric coupler and a power cable or transmission cable to a vehicle is shown. Schematic 200 includes first external load 180 (e.g., an AC electrical load), optional second external load 203 (e.g., a DC electrical load), electric coupler 151, electric port 150 (e.g., a receptacle), and charger 152.

Within electric coupler 151, circuitry 201 for identifying and transmitting cable and electric coupler operating conditions and limitations to a vehicle is shown. In particular, electric coupler 151 includes sockets 230-235 that are configured to interface with pins 236-241 of electric port 150. It is to be understood that sockets may be exchanged for pins and vise-versa. Circuitry 201 also includes a controller 210 (e.g., a microcontroller that may include a processor, non-transitory memory, random access memory, digital inputs/outputs, analog inputs/outputs), a capacitor 206, diode 208, buffers 212 and 214, optional transmitter 277, transistor 216, switch 218, temperature sensor 211, and a voltage divider circuit comprising resistor 220 and resistor 222.

Controller 210 is supplied with electrical power when electric coupler 151 is mated with electric port 150 via power supply 251 (e.g., 5 VDC). Pin 237 and socket 234 (e.g., proximity pilot pin/socket) may be referred to as proximity pins because they may carry a voltage (e.g., a proximity voltage) that may be indicative of the proximity of electric coupler 151 relative to electric port 150. In particular, voltage generated via power supply 251 may be reduced to a value at electric conductor 276, electric conductor 275, socket 234, and pin 237 that may be indicative of a predetermined cable/electric coupler identity as function of the resistance values of resistors 250 and 220 when electric coupler 151 is fully engaged with electric port 150. For example, a proximity voltage of 4.0 volts may indicate that the cable and electric coupler is configured to discharge 10 kW while a proximity voltage of 2.5 volts may indicate that the cable and electric coupler is configured to discharge 19 kW from the vehicle. The voltage at electric conductor 276, electric conductor 275, socket 234, and pin 237 (e.g., the proximity voltage) may be reduced from the level of the voltage produced by power supply 251 via each of resistors 250 and 220 when electric coupler 151 is fully engaged with electric port 150, which closes switch 218 to bypass resistor 222 as shown. However, if electric coupler 151 begins to be removed from electric port 150, switch 218 opens so that the voltage at electric conductor 276, electric conductor 275, socket 234, and pin 237 (e.g., the proximity voltage) is now a function of the resistance values of resistors 250, 220, and 222.

Power that is supplied by power supply 251 to capacitor 206 and controller 210 is supplied at a voltage that is equal to the voltage output of power supply 251 minus the voltage drop across resistor 250 minus the voltage drop across diode 208. Diode 208 allows electric charge to flow to capacitor 206 from power supply 251 when electric coupler 151 is fully engaged to electric port 150. Diode 208 prevents capacitor 206 from discharging through resistor 220 and/or transistor 216. Electric conductor 274 carries electric charge from diode 208 to capacitor 206. Controller 210 may determine whether the voltage at electric conductor 275, voltage at electric conductor 276, voltage at socket 234, and voltage at pin 237, which should be equivalent when electric coupler 151 is fully engaged with electric port 150, is a high or low level via digital input 210a. Buffer 213 may adjust the level of the proximity voltage (e.g., the voltage at electric conductor 275, voltage at electric conductor 276, voltage at socket 234, and voltage at pin 237) so that it is compatible with digital input 210a. Controller 210 may toggle the proximity voltage (e.g., voltage at electric conductor 275, voltage at electric conductor 276, voltage at socket 234, and voltage at pin 237 when electric coupler 151 is fully engaged with electric port 150) between a high level and a low level via digital output 210b driving buffer 214. Buffer 214 in turn may drive transistor 216 (e.g., an N-channel field effect resistor) to open and close operating as a switch in response to output of digital output 210b. For example, when gate 216g of transistor 216 is supplied with a higher voltage (e.g., >3.5 volts), transistor 216 may close to pull the proximity voltage and voltage at drain 216d close to ground (e.g., less than 0.5 volts) since source 216s is directly electrically coupled to ground. On the other hand, when gate 216g is supplied with a lower voltage (e.g., <0.5 volts), transistor 216 may be held open so that proximity voltage is determined by resistor 250, resistor 220, resistor 212. Thus, controller 210 may selectively open and close transistor 216 to change the proximity voltage. The proximity voltage may be used for serial communication between controller 210 and controller 158. Capacitor 206 supplies controller 210 with power when the proximity voltage is driven low by closing transistor 216. Thus, controller 210 is powered by the vehicle and may power up when electric coupler 151 is engaged with electric port 150.

In another representation, controller 210 may transmit or broadcast a radio frequency signal via transmitter 277 when electric coupler 151 is engaged with electric port 150. Controller 210 may broadcast the cable and electric coupler voltage capacity limits (e.g., maximum voltage that may be transferred via the cable and coupling), current capacity limits (e.g., maximum current that may be transferred via the cable and coupling), temperatures of the cable and coupling, and other manufacturing information and operating conditions via the signal.

Electric coupler 151 and its associated transmission cable may carry or deliver AC power to an external load 180 (e.g., an AC power consumer) via electric conductor 272, electric conductor 273, and sockets 232 and 233. Further, in some examples, electric coupler 151 and its associated transmission cable may carry or deliver DC power to an external load 203 (e.g., a DC power consumer) via electric conductor 270, electric conductor 271, and sockets 230 and 231.

Controller 158 of charger 152 may also communicate via a serial link that is formed by the level of the proximity voltage that may be carried or delivered via electric conductor 276 and electric conductor 275. Controller 158 may sense the level of the proximity voltage that may be carried or supplied by electric conductor 275 and electric conductor 276 via analog to digital (A/D) converter 252. Buffer 262 may adjust the level of the proximity voltage (e.g., the voltage at electric conductor 275, voltage at electric conductor 276, voltage at socket 234, and voltage at pin 237) so that it is compatible with digital input 158a. Controller 158 may toggle the proximity voltage (e.g., voltage at electric conductor 275, voltage at electric conductor 276, voltage at socket 234, and voltage at pin 237 when electric coupler 151 is fully engaged with electric port 150) between a high level and a low level via digital output 158b driving buffer 263. Buffer 263 in turn may drive transistor 260 (e.g., an N-channel field effect resistor) to open and close operating as a switch in response to output of digital output 158b. On the other hand, when gate 260g is supplied with a lower voltage (e.g., <0.5 volts), transistor 260 may be held open so that proximity voltage is determined by resistor 250, resistor 220, resistor 212. Thus, controller 158 may selectively open and close transistor 260 to change the proximity voltage. The proximity voltage may be used for serial communication between controller 210 and controller 158.

In another representation, controller 158 may receive data communicated by controller 210 and broadcast via radio frequency via receiver 278. As previously, mentioned the data may include electric coupler power limits, temperatures, and other data. Controller 158 may start to receive data as soon as electric coupler 151 is fully engaged with electric port 150. Electric port 150 is integral with the vehicle and it is not an external device.

DC to DC converter 285 may boost (increase), or in the alternative, buck (reduce) voltage output via electric energy storage device 132 (e.g., traction battery) for delivery to external load 203. Bidirectional AC/DC converter 284 may convert DC power supplied by electric energy storage device 132 to AC power for external load 180. Controller 158 may activate and control power output of DC to DC converter 285 and Bidirectional AC/DC converter 284 in response to data received from controller 210.

Referring now to FIG. 3, an example sequence where a power transfer cable and electric coupler is coupled to a vehicle is shown. The sequence of FIG. 3 may be generated via the system of FIGS. 1, 2, 5, and 6 in cooperation with the method of FIG. 4.

The first plot from the top of FIG. 3 is a plot of a proximity pin voltage on a vehicle side of an electric coupler to vehicle connection versus time. The vertical axis represents proximity pin voltage (e.g., a voltage at a proximity pin of the electric coupler) and the voltage increases in the direction of the vertical axis arrow. The horizontal axis represents time and time increases from the left side of the figure to the right side of the figure. Trace 302 represents the proximity pin voltage.

The second plot from the top of FIG. 3 is a plot of electric coupler connection or engagement state with an electric port of a vehicle versus time. The vertical axis represents the connection state of the electric coupler and the electric coupler is fully engaged to the electric port of the vehicle when trace 304 is near the vertical axis arrow. The electric coupler is not fully engaged with the electric port of the vehicle when trace 304 is near the horizontal axis. Trace 304 represents the electric coupler engagement state.

The third plot from the top of FIG. 3 is a plot of charge transfer state versus time. The vertical axis represents charge transfer state (e.g., whether or not the cable and electric coupler are transferring power or charge) and charge or electric power is being transferred via the electric coupler when trace 306 is at a level that is near the vertical axis arrow. The electric coupler is not transferring charge or power when trace 306 is at a lower level near the horizontal axis. Trace 306 represents the state of transfer of charge or power via the electric coupler and its associated cable.

At time t0, the proximity pin voltage is at a higher level to indicate that no electric coupler is coupled to the vehicle's electric port. The connection state indicates that there is no full connection between the electric coupler and the vehicle's electric port. Further, there is no charge or power transfer via the cable and electric coupler.

At time t1, the electric coupler begins to be inserted into the vehicle's electric port and the proximity pin voltage is lowered. The connection state indicates that there is no full connection between the electric coupler and the vehicle's electric port. Additionally, there is no charge or power transfer via the cable or electric coupler to an external load.

At time t2, the electric coupler is fully engaged with the vehicle input port and the proximity pin voltage changes to reflect the engagement. Shortly thereafter, the proximity voltage begins to toggle or switch between low voltage and a higher voltage to begin serial communication between the electric coupler controller and the charger controller. First, the charger controller requests data and then the electric coupler controller responds to the request. The data exchange ends at time t3 and the charger begins to allow electric power to be transferred from the vehicle to an external device. The charger may command and control the voltage and current that is output to the electric coupler and the external device.

At time t4, the electric power transfer is completed when a user begins to remove the electric coupler from the vehicle's electric port. The user depresses a button, which causes the proximity pin voltage to change. The charger commands the electric power transfer to cease and the electric power transfer is ended before the electric coupler is fully decoupled from the vehicle's electric port.

In this way, electric coupler data may be communicated to a vehicle via a serial communications link that increases the functionality of the proximity pin voltage. The serial communication is bidirectional allowing the charger to issue commands and allowing the electric coupler to respond to the commands.

Referring now to FIG. 4, an example method for operating an electric vehicle is shown. The method of FIG. 4 may be incorporated into and may cooperate with the systems of FIGS. 1, 2, 5 and 6. Further, at least portions of the method of FIG. 4 may be incorporated as executable instructions stored in non-transitory memory of one or more controllers while other portions of the method may be performed via the one or more controllers transforming operating states of devices and actuators in the physical world.

At 402, method 400 monitors a voltage that may be applied to a pin or socket of an electric power coupler. In one example, the voltage may be a voltage of a proximity pin as mentioned in the description of FIG. 2. Method 400 may monitor the voltage via an A/D converter that outputs its data to a controller. Method 400 proceeds to 404.

At 404, method 400 judges whether or not the voltage that is being monitored is within a specific range for identification of an electric coupler. The voltage may be a voltage that is selected by a manufacturer of the coupler and/or the vehicle and it may be unique to the specific type of electric coupler. If method 400 judges that the voltage is in range to identify the coupler, the answer is yes and method 400 proceeds to 406. Otherwise, method 400 proceeds to 420.

At 420, method 400 prevents output of power from the vehicle to the electric coupler and power transmission cable. In one example, the vehicle charger commands a DC/DC converter or a bidirectional converter to zero output. Method 400 proceeds to exit.

At 406, the vehicle's charger commands the electric coupler to identify itself and its capabilities. In one example, the vehicle's charger may command the electric coupler via a serial communication link between the vehicle and the electric coupler. The serial communications link may comprise a proximity pin of the electric coupler and a low voltage source of the vehicle's charger. Further, the serial communications link may include transistors and resistors arranged as shown in FIG. 2 or an arrangement that performs similarly. The electric couplers capabilities may include but may not be limited to a maximum amount of electric current, electric power, and/or electric voltage that may be carried by or transferred via the electric coupler. Further, the coupler may identify whether the coupler is configured to carry or transmit AC and/or DC power. Method 400 proceeds to 408.

At 408, the electric coupler responds to the request from the vehicle and provides the requested information via a serial communication link. The serial communications link may be formed via adding functionality to a proximity detection circuit as discussed with regard to FIG. 2. Method 400 proceeds to 410.

At 410, method 400 commands a bidirectional converter and/or a DC/DC converter according to the data that was provided by the electric coupler to the charger via the serial link. For example, if the power transfer or delivery capacity of the electric coupler is 19 kilowatts, the bidirectional converter and/or DC/DC converter are commanded to output no more than 19 kilowatts of electric power. Additionally, method 400 may command the bidirectional converter and/or the DC/DC power output to be limited or constrained to less than a threshold amount of power, where the threshold amount of power is based on a temperature and/or other operating conditions of the electric coupler. Method 400 proceeds to exit.

In an alternative embodiment where the electric coupler transmits a radio frequency signal, the vehicle charger may receive the signal and command the bidirectional converter and the DC/DC converter according to the data that was transmitted by the electric coupler to the vehicle charger.

Thus, the method of FIG. 4 provides for a method for supplying electric power from a vehicle, comprising: sensing a voltage that is indicative of an electric coupler having serial communications capability via circuitry of the vehicle, where the voltage is sensed at an electric conductor; and requesting identification data for the electric coupler via circuitry of the vehicle. In a first example, the method includes where the requesting identification is performed via a serial communications link. In a second example that may include the first example, the method includes where the serial communications link is integral with a proximity detection circuit of the electric coupler and a vehicle electrical charging/discharging circuit. In a third example that may include one or both of the first and second examples, the method further comprises responding to the requesting identification data via circuitry of the electric coupler. In a fourth example that may include one or more of the first through third examples, the method includes where responding to the requesting identification data includes communicating maximum voltage and current carrying capacity of the electric coupler. In a fifth example that may include one or more of the first through fourth examples, the method includes where the circuitry of the electric coupler includes a controller. In a sixth example that may include one or more of the first through fifth examples, the method further comprises transmitting data including temperature of the electric coupler to the vehicle via the circuitry of the electric coupler.

Referring now to FIG. 5, a side view of an electric coupler 151 is shown. Electric coupler includes a body 502 that may be formed of an electrically insulating material. Body 502 may house the electric coupler circuitry shown in FIG. 2. Electric coupler 151 also includes a society of automotive engineers (S.A.E.) J1772 electrical connector 504 that may include pins/sockets to carry electric power from/to a vehicle to/from an external load/source. AC power may be carried and/or transferred via the electrical connector. Optionally, electric coupler 151 may include a second connector 506 for carrying or transmitting DC electric power (e.g., for DC fast charging/discharging).

Referring now to FIG. 6, an end view of an electric coupler 151 is shown. Pins/sockets of electric coupler 151 are shown. In particular, connector 504 includes a first AC L1 pin 602, a second AC neutral or L2 pin 604, ground pin 610, proximity pilot pin 606, and control pilot pin 608. Connector 506 includes a DC+pin 612 and DC−pin 614.

Thus, the system of FIGS. 1, 2, 5, and 6 provides for an electric coupler for an electric vehicle, comprising: an electric conductor electrically coupled a voltage divider circuit, a transistor, and circuitry configured to identify one or more attributes of the electric coupler. In a first example, the electric coupler includes where the electric conductor is electrically coupled to a proximity pilot pin of a SAE J1772 connector. In a second example that may include the first example, the electric coupler includes where the voltage divider circuit is comprised of a first resistor and a second resistor. In a third example that may include one or both of the first and second examples, the electric coupler includes where the electric conductor is electrically coupled directly to a drain of the transistor. In a fourth example that may include one or more of the first through third examples, the electric coupler includes where the circuitry configured to identify one or more attributes of the electric coupler is a microcontroller. In a fifth example that may include one or more of the first through fourth examples, the electric coupler includes where the microcontroller is electrically coupled directly to a gate of the transistor. In a sixth example that may include one or more of the first through fifth examples, the electric coupler includes where electrical ground is electrically coupled directly to a source of the transistor. In a seventh example that may include one or more of the first through sixth examples, the electric coupler further comprises a temperature sensor in electrical communication with the microcontroller.

Thus, the system of FIGS. 1, 2, 5, and 6 provides for an electric coupling system for an electric vehicle, comprising: an electrical plug included with the electric vehicle; a first circuit included in the electric vehicle, the first circuit in electrical communication with the electrical plug and configured to sense a voltage associated with a pin of the electrical plug and communicate with an external electric coupler via adjusting the voltage. In a first example, the electric coupling system further comprises a power source electrically coupled to a pin of the electrical plug. In a second example that may include the first example, the electric coupling system further comprises a second circuit included in an electric coupler that includes a controller that is configured to be powered via the power source. In a third example that may include one or both of the first and second examples, the electric coupling system further comprises executable instructions stored in non-transitory memory that cause the controller to communicate with the electric vehicle. In a fourth example that may include one or more of the first through third examples, the electric coupling system includes where communicating with the electric vehicle includes transmitting operating conditions of the electric coupler.

Note that the example control and estimation routines included herein can be used with various vehicle and powertrain configurations. The control methods and routines disclosed herein may be stored as executable instructions in non-transitory memory and may be carried out by the control system including the controller in combination with the various sensors, actuators, and other vehicle hardware.

Further, portions of the methods may be physical actions taken in the real world to change a state of a device. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example examples described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the vehicle control system, where the described actions are carried out by executing the instructions in a system including the various vehicle hardware components in combination with the electronic controller. One or more of the method steps described herein may be omitted if desired.

It will be appreciated that the configurations and routines disclosed herein are exemplary in nature, and that these specific examples are not to be considered in a limiting sense, because numerous variations are possible. For example, the above technology can be applied to induction electric machines and permanent magnet electric machines. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims may be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An electric coupler for an electric vehicle, comprising:
an electric conductor electrically coupled a voltage divider circuit, a transistor, and circuitry configured to identify one or more attributes of the electric coupler.

2. The electric coupler of claim 1, where the electric conductor is further coupled a proximity pilot pin of a SAE J1772 connector.

3. The electric coupler of claim 1, where the voltage divider circuit is comprised of a first resistor and a second resistor.

4. The electric coupler of claim 1, where the electric conductor is electrically coupled directly to a drain of the transistor.

5. The electric coupler of claim 1, where the circuitry configured to identify one or more attributes of the electric coupler is a microcontroller.

6. The electric coupler of claim 5, where the microcontroller is electrically coupled directly to a gate of the transistor.

7. The electric coupler of claim 5, where electrical ground is electrically coupled directly to a source of the transistor.

8. The electric coupler of claim 7, further comprising a temperature sensor in electrical communication with the microcontroller.

9. A method for supplying electric power from a vehicle, comprising:
sensing a voltage that is indicative of an electric coupler having serial communications capability via circuitry of the vehicle, where the voltage is sensed at an electric conductor; and
requesting identification data for the electric coupler via circuitry of the vehicle.

10. The method of claim 9, where requesting identification is performed via a serial communications link.

11. The method of claim 10, where the serial communications link is integral with a proximity detection circuit of the electric coupler and a vehicle electrical charging/discharging circuit.

12. The method of claim 9, further comprising responding to the requesting identification data via circuitry of the electric coupler.

13. The method of claim 12, where responding to the requesting identification data includes communicating maximum voltage and current carrying capacity of the electric coupler.

14. The method of claim 12, where the circuitry of the electric coupler includes a controller.

15. The method of claim 14, further comprising transmitting data including temperature of the electric coupler to the vehicle via the circuitry of the electric coupler.

16. An electric coupling system for an electric vehicle, comprising:
an electrical plug included with the electric vehicle;
a first circuit included in the electric vehicle, the first circuit in electrical communication with the electrical plug and configured to sense a voltage associated with a pin of the electrical plug and communicate with an external electric coupler via adjusting the voltage.

17. The electric coupling system of claim 16, further comprising a power source electrically coupled to the pin of the electrical plug.

18. The electric coupling system of claim 17, further comprising a second circuit included in an electric coupler that includes a controller that is configured to be powered via the power source.

19. The electric coupling system of claim 18, further comprising executable instructions stored in non-transitory memory that cause the controller to communicate with the electric vehicle.

20. The electric coupling system of claim 19, where communicating with the electric vehicle includes transmitting operating conditions of the electric coupler.
